(19) United States
(12) Patent Application Publication
(10) Pub. No.: US 2014/0048019 A1
(43) Pub. Date: Feb. 20, 2014

(54) ELECTRONIC FENCE APPARATUS USING GPS

(71) Applicant: DOGTRA CO., LTD., Incheon (KR)

(72) Inventor: Min Jae SO, Seoul (KR)

(73) Assignee: DOGTRA CO., LTD., Incheon (KR)

(21) Appl. No.: 13/689,990

(22) Filed: Nov. 30, 2012

(30) Foreign Application Priority Data
Aug. 17, 2012 (KR) 10-2012-0090063

(51) Int. Cl. A01K 15/04

(52) U.S. Cl. CPC A01K 15/04
USPC 119/721

(57) ABSTRACT

Disclosed is an electronic fence apparatus using a GPS, which sets a boundary of an activity area of an animal by using GPS information, determines a position of the animal, and prevents the animal from escaping from the set activity area by applying a vibration or an electronic stimulation when the animal approaches the boundary of the activity area. Accordingly, it is possible to inform the user of a state of the animal while controlling the animal not to escape from a predetermined area by setting the electronic fence through GPS information, detecting the position of the animal, and generating a sound or applying the vibration or the electronic stimulation to the animal when the animal approaches the electronic fence.

### BACKGROUND OF THE INVENTION

1. Field of the Invention

The present invention relates to an electronic fence apparatus using a GPS, and more particularly to a an electronic fence apparatus using a GPS which sets a boundary of an activity area of an animal by using the GPS, determines a position of the animal, and applies a vibration or an electrical stimulation when the animal approaches the boundary of the activity area to prevent the animal from escaping the set activity area.

2. Description of the Prior Art

Recently, with the improvement of the quality of life, the number of households considering animals such as a dog, a cat and the like as a family member is continuously increased and thus pet related businesses are steadily increased.

Accordingly, various animal products having good quality, for example, a dye and a leash or a collar connected to an animal's body as well as food for animals have been greatly released.

Further, people install a fence made of posts and a net to secure spaces where animals freely move somewhat or attach a GPS receiver to the animal to detect a position of the animal through a GPS satellite.

However, the fence made of the posts and the net has a disadvantage in that installation costs are expensive and a problem in that manpower and costs must be spent on maintenance due to damage from external forces such as rain and wind.

Further, since the fence is fixedly installed and difficult to be carried, activity areas of the animal cannot help but being restricted by connecting a leash to the animal's body when taking the animal outdoors

In addition, a position of the animal may be detected by attaching the GPS receiver to the animal, but if there is an obstacle such as an outdoor pond, a master should continuously keep eyes on the animal not to approach the obstacle.

### SUMMARY OF THE INVENTION

Accordingly, the present invention has been made to solve the above-mentioned problems, and the present invention provides an electronic fence apparatus using a GPS, which sets an electronic fence through GPS information, detects a position of an animal to generate a sound when the animal approaches the electronic fence, and informs a user of the position of the animal while controlling the animal not to escape from a predetermined area by applying a vibration or an electronic stimulation to the animal.

Also, the present invention provides an easily carried electronic fence apparatus using a GPS, which reduces installation and maintenance costs of the fence by registering a position of a virtual post by using GPS information and setting a boundary of an activity area of the animal through the registered position of the post.

In accordance with an aspect of the present invention, there is provided an electronic fence apparatus using a GPS, the electronic fence apparatus including: a GPS module for communicating with a GPS satellite; a post position setting unit for receiving coordinate data of a current position from the GPS module and storing the received coordinate data as information on a position where a post is installed when a post position setting key is input; an electronic fence setting unit for calculating coordinate data of a line connecting posts through the information on the position where the post is installed and storing the calculated coordinate data as information on a position where an electronic fence is installed; and a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

In accordance with another aspect of the present invention, there is provided an electronic fence apparatus using a GPS, the electronic fence apparatus including: a GPS module for communicating with a GPS satellite; a post position setting unit for, when receiving coordinate data through a key input, storing the received coordinate data as information on a position where a post is installed; an electronic fence setting unit for calculating coordinate data of a line connecting posts through the information on the position where the post is installed and storing the calculated coordinate data as information on a position where an electronic fence is installed; and a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

The electronic fence apparatus may further include a storage unit for storing the information on the position where the post is installed and position information set as the electronic fence; a vibration generator for generating a vibration, the vibration generator coming into contact with a body of an animal; an electronic stimulation generator for generating an electronic stimulation, the electronic stimulation generator coming into contact with the body of the animal; and a sound generator for outputting a sound.

In accordance with another aspect of the present invention, there is provided an electronic fence apparatus using a GPS, the electronic fence apparatus including: an electronic fence transmission device including: a GPS module for communication with a GPS satellite; and a transmitter for receiving coordinate data of a current position from the GPS module and transmitting the received coordinate data when a post position setting key is input; and an electronic fence reception device including: a GPS module for communicating with the GPS satellite; a receiver for receiving coordinate data from the electronic fence transmission device; a post position setting unit for storing the received coordinate data as information on a position where a post is installed; an electronic fence setting unit for calculating coordinate data of a line connecting posts through the information on the position where the post is installed and storing the calculated coordinate data as information on a position where an electronic fence is installed; and a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

In accordance with another aspect of the present invention, there is provided an electronic fence apparatus using a GPS, the electronic fence apparatus including: an electronic fence transmission device including: a GPS module for communicating with a GPS satellite; and a transmitter for receiving coordinate data through a key input and transmitting the received coordinate data; and an electronic fence reception device including: a GPS module for communicating with the GPS satellite; a receiver for receiving coordinate data from the electronic fence transmission device; a post position setting unit for storing the received coordinate data as information on a position where a post is installed; an electronic fence setting unit for calculating coordinate data of a line connecting posts through the information on the position where the post is installed and storing the calculated coordinate data as information on a position where an electronic fence is installed; and a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

The electronic fence reception device may further include a storage unit for storing the information on the position where the post is installed and position information set as the electronic fence; a vibration generator for generating a vibration, the vibration generator coming into contact with a body of an animal; an electronic stimulation generator for generating an electronic stimulation, the electronic stimulation generator coming into contact with the body of the animal; and a sound generator for outputting a sound.

When a number of information on the position where the post is installed is one, the electronic fence setting unit may calculate coordinate data of a circle having the information on the position where the post is installed as a central point and set the calculated coordinate data as the information on the position where the electronic fence is installed.

The stimulation generator may generate the electronic stimulation, the vibration, or the sound having a stronger intensity as the received coordinate data is closer to the position information set as the electronic fence.

The electronic fence apparatus may further include an RFID reader for, when the post is actually installed, reading an RFID tag installed in the post, wherein, when tag information of the RFID tag read through the RFID reader corresponds to preset tag information, the stimulation generator generates at least one of the electronic stimulation, the vibration, or the sound.

According to the present invention, there is an effect of informing a user of a state of an animal while controlling such that the animal cannot escape from a predetermined area by setting an electronic fence through GPS information, detecting a position of the animal, and generating a sound and applying a vibration or an electronic stimulation to the animal when the animal approaches the electronic fence.

Also, there is an effect in that installation and maintenance costs of the fence may be reduced and high portability may be obtained by registering a position of a virtual post and setting a boundary of activity areas of the animal through the registered position of the post.

### BRIEF DESCRIPTION OF THE DRAWINGS

FIG. 1 is an external configuration diagram of an electronic fence apparatus using a GPS according to an embodiment of the present invention.

FIG. 2 is an external configuration diagram of an electronic fence transmission device according to an embodiment of the present invention.

FIG. 3 is a flowchart for describing a process of limiting activity areas of an animal by setting an electronic fence in an electronic fence apparatus using a GPS according to an embodiment of the present invention.

FIG. 4 illustrates an electronic fence set using one piece of coordinate data set as position information of a post according to an embodiment of the present invention.

FIG. 5 illustrates an electronic fence set using two pieces of coordinate data set as position information of a post according to an embodiment of the present invention.

FIGS. 6 and 7 illustrate an electronic fence set using four pieces of coordinate data set as position information of a post according to an embodiment of the present invention.

FIG. 8 illustrates an electronic fence set using eight pieces of coordinate data set as position information of a post according to an embodiment of the present invention.

FIG. 9 illustrates an electronic fence set to limit activity areas of an animal by using an RFID according to an embodiment of the present invention.

### DETAILED DESCRIPTION OF THE EXEMPLARY EMBODIMENTS

Hereinafter, exemplary embodiments of the present invention will be described in detail with reference to the accompanying drawings to enable those skilled in the art to easily implement the present invention.

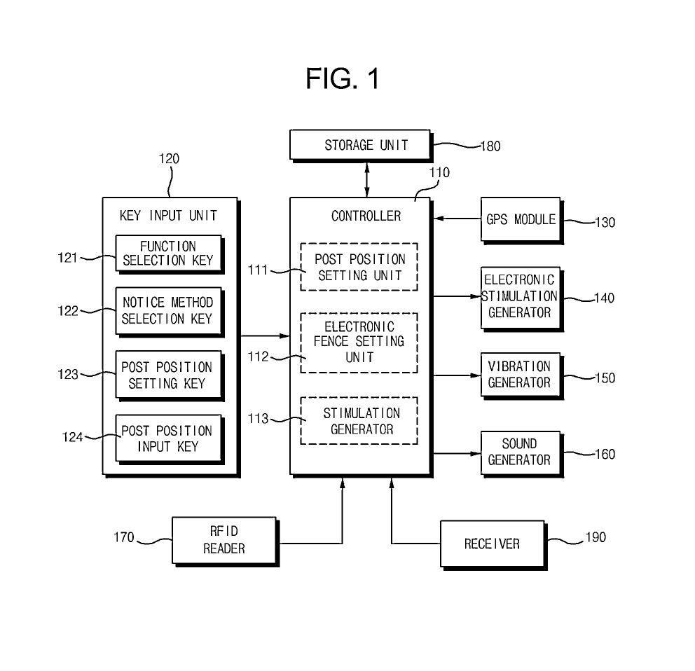

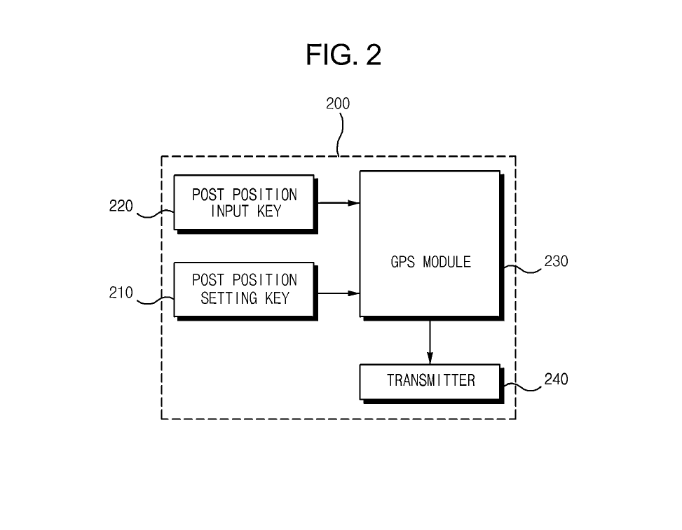

FIG. 1 is an external configuration diagram of an electronic fence apparatus using a GPS according to an embodiment of the present invention, and FIG. 2 is an external configuration diagram of an electronic fence transmission device according to another embodiment of the present invention.

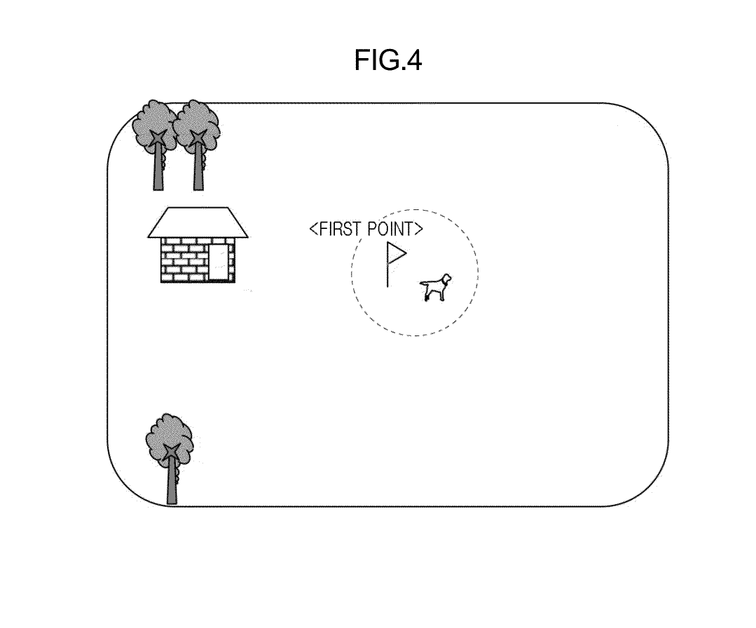

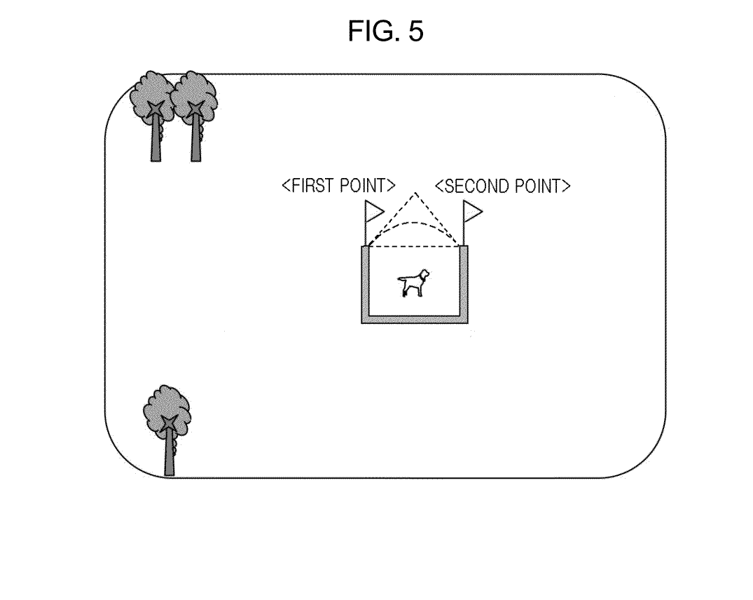

Further, FIG. 4 illustrates an electronic fence set using one piece of coordinate data set as position information of a post according to an embodiment of the present invention, and FIG. 5 illustrates an electronic fence set using two pieces of coordinate data set as position information of a post according to an embodiment of the present invention.

Referring to FIGS. 1, 2, 4, and 5, the electronic fence apparatus using the GPS includes a controller 110, a key input unit 120, a GPS module 130, an electronic stimulation generator 140, a vibration generator 150, a sound generator 160, an RFID reader 170, a storage unit 180, and a receiver 190.

The key input unit 120 includes a function selection key 121 for selecting whether to perform an electronic fence function using the GPS or an electronic fence function using the RFID, a notice method selection key 122 for selecting to perform at least one of the electronic stimulation, the vibration, and the sound when the animal approaches the electronic fence, a post position setting key 123 for registering coordinate data of a current position as a position where the post is installed for setting the electronic fence, and a post position input key 124 for receiving coordinate data for registering coordinate data of a particular point as the position where the post is installed for setting the electronic fence.

The GPS module 130 communicates with the GPS satellite at regular time intervals to receive coordinate data for a position of the electronic fence apparatus 100, and transmits the received coordinate data to the controller 110.

The electronic stimulation generator 140 includes a pair of electric shock terminals coming into contact with a body of the animal, and controls an intensity of electricity (voltage or current) flowing through the electric shock terminals according to a control of the controller 110.

The vibration generator 150 includes a motor coming into contact with the body of the animal to generate a vibration, and generates the vibration while controlling an intensity of the vibration according to a control of the controller 110.

The sound generator 160 outputs a preset sound when it is determined that the animal approaches the electronic fence.

When the RFID reader 170 recognizes an RFID tag, the RFID reader 170 reads the recognized RFID tag and transmits tag information of the read RFID tag to the controller 110.

The storage unit 180 stores tag information of a post having the RFID tag installed therein to perform an electronic fence function using the RFID, stores coordinate data set as position information of the post to perform an electronic fence function using the GPS, and stores coordinate data set as position information of the electronic fence.

The receiver 190 receives coordinate data.

The controller 110 includes a post position setting unit 111, an electronic fence setting unit 112, and a vibration generator 113, and controls a general operation of the electronic fence apparatus 100 using the GPS.

When the post position registration key 123 is input, the post position setting unit 111 receives coordinate data of a current position through the GPS module 130 and stores the received coordinate data as information on the position where the post is installed.

That is, the post position setting unit 111 receives the coordinate data of the current position through the GPS module 130 whenever the post position registration key 123 is input, and sequentially stores the received data as information on positions where a first post, a second post, a third post and the like are installed.

At this time, the information on the position where the post is installed includes a position where the post position registration key 123 is input, and it is not necessarily required to install the post at the position but the user should move to a position desired to be set as the post position and directly input the post position registration key 123.

Further, the post position setting unit 111 may receive coordinate data of a particular position where the post will be installed through the post position input key 124 and store the coordinate data as the information on the position where the post is installed. At this time, it is preferable that the post position input key 124 is a character input key.

In addition, when the post position setting unit 111 receives the coordinate data through the receiver 190, the post position setting unit 111 stores the received coordinate data as the information on the position where the post is installed.

In a description of a process of setting position information of the electronic fence by the electronic fence setting unit 112 with reference to FIGS. 4 and 5, when information on one position where the post is installed is set as illustrated in FIG. 4, the electronic fence setting unit 112 calculates coordinate data of a circle having the information on the position where one post is installed as a central point and sets the coordinate data as position information of the electronic fence.

At this time, the coordinate data set as the position information of the electronic fence is calculated at regular intervals on the circle.

Further, when information on two or more positions where the post is installed is set, the electronic fence setting unit 112 calculates coordinate data of a line connecting two posts and sets the coordinate data as information on the position where the electronic fence is installed as illustrated in FIG. 5.

Similarly at this time, the coordinate data is calculated at regular intervals on the line connecting the two posts.

At this time, when information on two positions where the post is installed is set as illustrated in FIG. 5, it is preferable that three sides except for a part where the electronic fence is set are closed.

Further, when the electronic fence is set using information on positions where two or more posts are installed, any lines such as a straight line, a curved line and the like may be applied as long as the line connects two posts.

The stimulation generator 113 selects the electronic fence function using the GPS through the function selection key 121, and receives coordinate data according to a current position through the GPS module 130 at regular time intervals when the position information of the electronic fence is set.

At this time, it is preferable that the received coordinate data is position information of the animal.

The stimulation generator 113 receives coordinate data according to the position of the animal at regular time intervals and compares the received coordinate data with position information of the electronic fence.

Further, the stimulation generator 113 determines a proximity distance between the coordinate data according to the position of the animal and the information on the position where the electronic fence is installed, and generates at least one of the electronic stimulation, the vibration, or the sound having a stronger intensity as the animal approaches the electronic fence.

At this time, the intensity of the electronic stimulation, the vibration, or the sound generated according to the proximity distance of the electronic fence may be set in advance by the user. The user may recognize how closely the animal approaches the electronic fence according to the intensity of the sound, and the animal cannot escape from the electronic fence since the intensity of the electronic stimulation or the vibration is stronger as the animal approaches the electronic fence.

Further, the stimulation generator 113 selects the electronic fence function using the RFID through the function selection key 121. When an RFID tag is read through the RFID reader 170, the stimulation generator 113 determines whether information on the read RFID tag corresponds to information on a preset RFID tag.

At this time, it is preferable to install the post to which the RFID tag is attached in order to use the electronic fence function using the RFID function, and to pre-store tag information on the RFID tag installed in the post in the electronic fence apparatus 100.

Accordingly, when the information on the read RFID tag corresponds to the pre-stored information on the RFID tag, the stimulation generator 113 determines that the animal is located within a predetermined distance from the post set by the electronic fence, and outputs at least one of the electronic stimulation, the vibration, or the sound.

Meanwhile, as another embodiment of the present invention, the electronic fence apparatus 100 may include an electronic reception device including the controller 110, the function selection key 121, the notice method selection key 122, the GPS module 130, the electronic stimulation generator 140, the vibration generator 150, the sound generator 160, the RFID reader 170, the storage unit 180, and the receiver 190, and an electronic fence transmission device 200 including a post position input key 220, a post position setting key 210, a GPS module 230, and a transmitter 240 as illustrated in FIG. 2.

That is, when the user transmits coordinate data according to the position of the post of the electronic fence to the electronic fence reception device while carrying only the electronic fence transmission device 200, the electronic fence is set using the coordinate data received by the electronic fence reception device.

In a more detailed description, when the post position setting key 210 is input, the electronic fence transmission device 200 receives coordinate data of a current position through the GPS module 230 and transmits the received coordinate data to the electronic fence reception device by using the transmitter 240.

Further, when the electronic fence transmission device 200 receives the coordinate data through the post position input key 220, the electronic fence transmission device 200 transmits the received coordinate data to the electronic fence reception device by using the transmitter 240.

Then, the post position setting unit 111 of the electronic fence reception device stores the coordinate data received from the electronic fence transmission device 200 as information on the position where the post is installed.

Further, the electronic fence setting unit 112 of the electronic fence reception device calculates coordinate data where the electronic fence is installed by using the information on the position where the post is installed, and stores the calculated coordinate data as position information of the electronic fence. Thereafter, the stimulation generator 113 of the electronic fence reception device periodically receives the coordinate data according to the position of the animal through the GPS module 130, and outputs the electronic stimulation or the vibration when the position of the animal approaches the electronic fence.

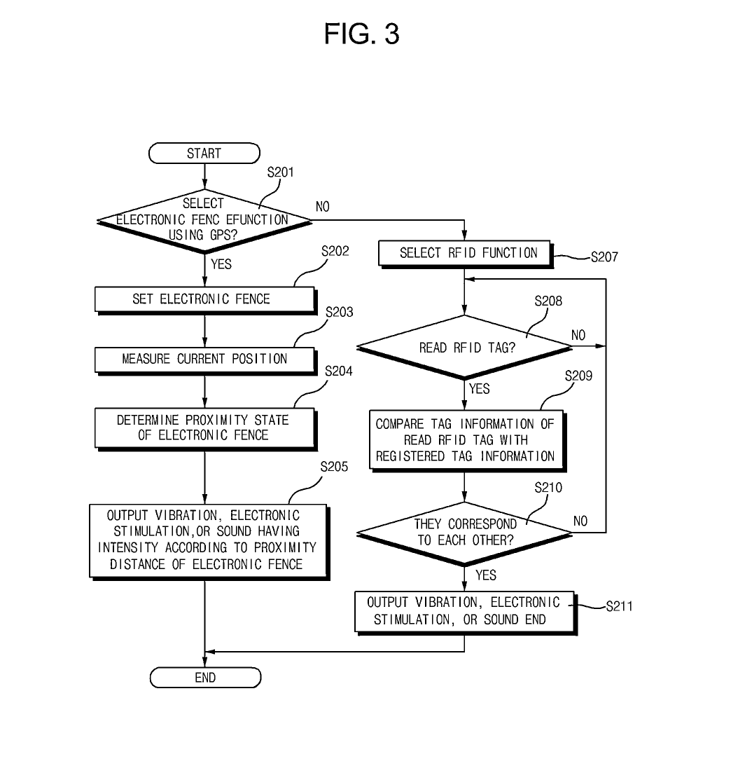

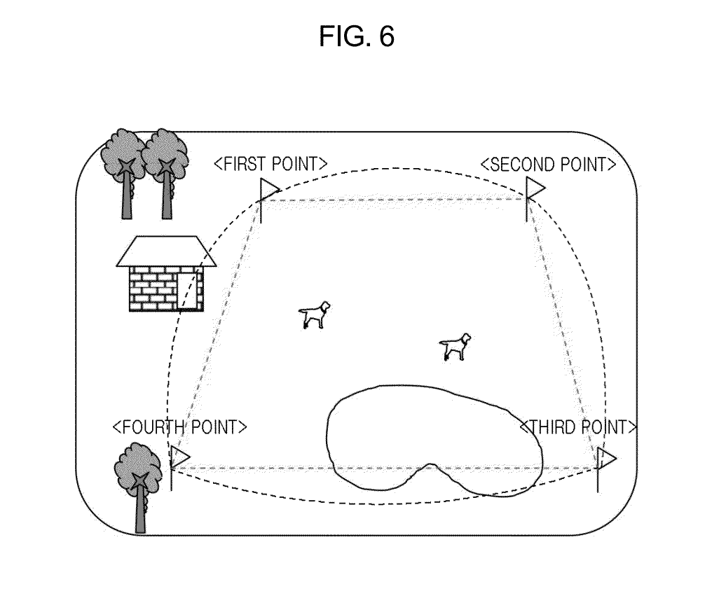

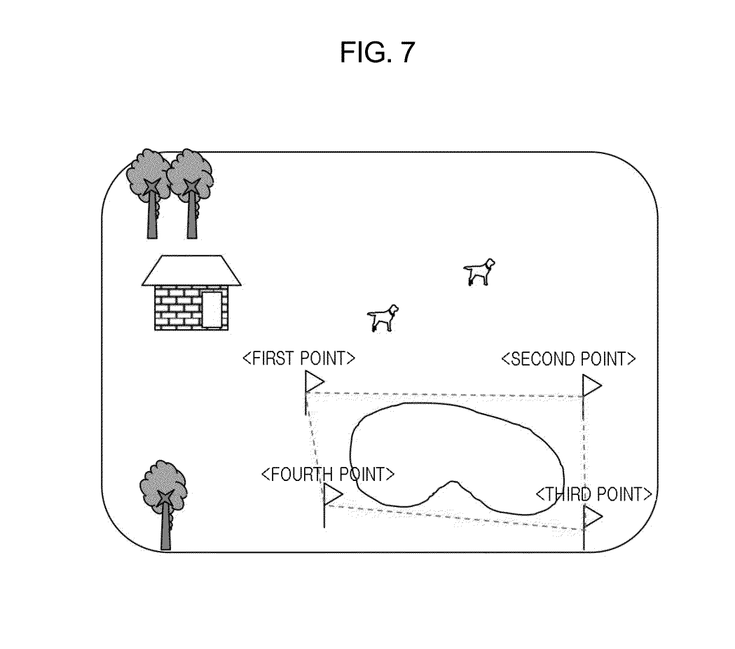

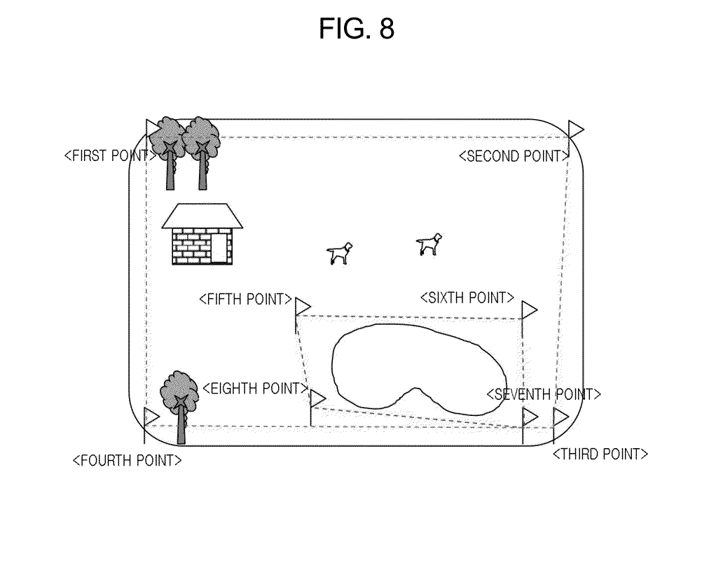

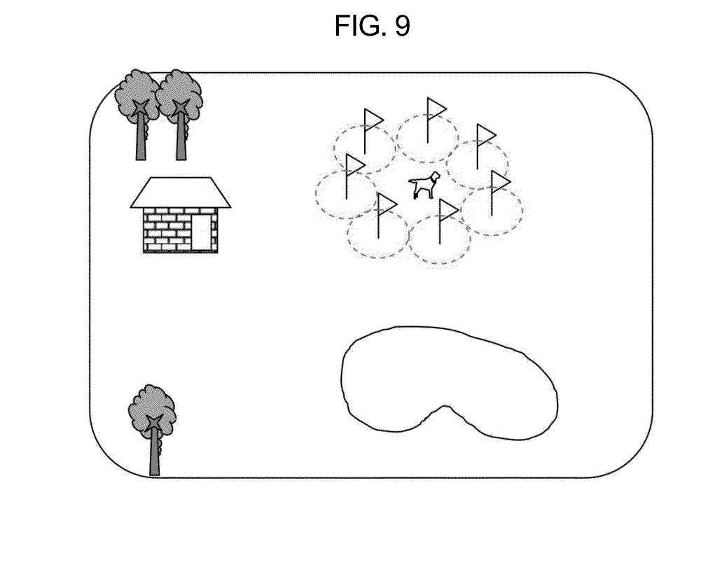

FIG. 3 is a flowchart for describing a process of limiting activity areas of the animal by setting the electronic fence in the electronic fence apparatus using the GPS according to an embodiment of the present invention, FIGS. 6 and 7 illustrate the electronic fence set using four pieces of coordinate data set as position information of the post according to an embodiment of the present invention, FIG. 8 illustrates the electronic fence set using eight pieces of coordinate data set as position information of the post according to an embodiment of the present invention, and FIG. 9 illustrates an electronic fence set to limit activity areas of an animal by using the RFID according to an embodiment of the present invention.

Referring to FIG. 3 and FIGS. 6 to 9, when an electronic fence function using the GPS is selected in step S201, the stimulation generator 113 receives a setting of a boundary for an activity area of the animal, that is, an electronic fence area in step S202.

At this time, the electronic fence area may be set in advance, or may be set when it is desired to perform the GPS electronic fence function as described above.

In a description of the process of setting the electronic fence area with reference to FIGS. 6 to 9, when the post position setting unit 111 receives coordinate data of first to fourth posts through the post position setting key 123, the post position input key 124, or the electronic fence transmission device 200 as illustrated in FIG. 6 or 7, the post position setting unit 111 sets information on the positions where the first to fourth posts are installed by using corresponding coordinate data.

At this time, the first to fourth posts may be actually installed, or may be set as virtual posts.

Further, when actual posts are installed, an RFID tag is installed in each post and used for the electronic fence function using the RFID according to selection of the function selection key 121.

However, when the electronic fence function using the RFID is used after the posts are installed as illustrated in FIG. 6 or 7, a space may occur where the RFID tag cannot be read according to a reading distance of the RFID tag since a distance between respective posts is far.

Accordingly, when the electronic fence function using the RFID is desired to be used, it is required to install the posts such that distance between respective posts to which the RFID tag is attached is close as illustrated in FIG. 8.

Therefore, it is preferable that the electronic fence function using the RFID is applied when the activity area of the animal is desired to be narrowly set.

Through the above-described process, when position information on the first to fourth posts is set, the electronic fence setting unit 112 calculates coordinate data of lines connecting the first post and the second post, the second post and the third post, the third post and the fourth post, and the fourth post and the first post, and sets the calculated coordinate data as information on the position where the electronic fence is installed.

Here, the information on the position where the electronic fence is installed is a position corresponding to a dotted line shown in FIG. 6 or 7, and the electronic fence setting unit 112 calculates coordinate data of lines connecting the posts and sets the calculated coordinate data as information on the position where the electronic fence is installed.

At this time, it is preferable that the electronic fence setting unit 112 sets only an outer part of the lines connecting the posts as the information on the position where the electronic fence is installed.

Meanwhile, the electronic fence of the present invention may be used as the boundary for limiting the activity area of the animal through the above-described process as illustrated in FIG. 6, but may be used as the electronic fence for preventing the animal from approaching a dangerous area as illustrated in FIG. 7.

In this case, respective posts are installed in four points near the pond as illustrated in FIG. 7, and the electronic fence may be set by storing position information of the respective posts.

Further, as illustrated in FIG. 8, the boundary of the activity area of the animal is set by setting position information of eight posts, and simultaneously the boundary for limiting approach to the dangerous area may be set.

Meanwhile, when the electronic fence is set in step S202 through the above-described process, the stimulation generator 113 measures information on a current position through the GPS module 130 at regular time intervals in step S203.

At this time, the measured information on the current position is position information of the animal.

Further, the stimulation generator 113 determines whether the current position of the animal in step S204 is close to the position of the electronic fence set in step S202.

In addition, it is determined that the animal is close to the electronic fence, the stimulation generator 113 generates the electronic stimulation, the vibration, or the sound having a corresponding intensity according to a proximity distance between the animal and the electronic fence in step S205.

Meanwhile, when the electronic fence function using the RFID is selected, the stimulation generator 113 identifies the selection in step S207, and determines whether the RFID tag is read in step S208.

Further, the stimulation generator 113 determines whether information on the read RFID tag corresponds to pre-stored tag information in step S209.

In addition, when there is tag information corresponding to the pre-stored tag information in step S210, the stimulation generator 113 identifies a section where the approach is restricted, and performs at least one operation of outputting the vibration, the electronic stimulation, and the sound in step S211.

Accordingly, the user can install the fence for limiting the activity area of the animal without installation of the fence including the post and leash, and conveniently set the activity area of the animal while moving since there is no need of separate movement and installation.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An electronic fence apparatus using a GPS, the electronic fence apparatus comprising:
a GPS module for communicating with a GPS satellite;
a post position setting unit for receiving coordinate data of a current position from the GPS module and storing the received coordinate data as information on a position where a post is installed when a post position setting key is input;
an electronic fence setting unit for calculating coordinate data of a line connecting posts through the information on the position where the post is installed and storing the calculated coordinate data as information on a position where an electronic fence is installed; and
a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

2. An electronic fence apparatus using a GPS, the electronic fence apparatus comprising:
a GPS module for communicating with a GPS satellite;
a post position setting unit for, when receiving coordinate data through a key input, storing the received coordinate data as information on a position where a post is installed;
an electronic fence setting unit for calculating coordinate data of a line connecting posts through the information on the position where the post is installed and storing the calculated coordinate data as information on a position where an electronic fence is installed; and
a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

3. An electronic fence apparatus using a GPS, the electronic fence apparatus comprising:
an electronic fence transmission device comprising:
a GPS module for communication with a GPS satellite; and
a transmitter for receiving coordinate data of a current position from the GPS module and transmitting the received coordinate data when a post position setting key is input; and
an electronic fence reception device comprising:
a GPS module for communicating with the GPS satellite;
a receiver for receiving coordinate data from the electronic fence transmission device;
a post position setting unit for storing the received coordinate data as information on a position where a post is installed;
an electronic fence setting unit for calculating coordinate data of a line connecting posts through the information on the position where the post is installed and storing the calculated coordinate data as information on a position where an electronic fence is installed; and
a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

4. An electronic fence apparatus using a GPS, the electronic fence apparatus comprising:
an electronic fence transmission device comprising:
a GPS module for communicating with a GPS satellite; and
a transmitter for receiving coordinate data through a key input and transmitting the received coordinate data; and
an electronic fence reception device comprising:
a GPS module for communicating with the GPS satellite;
a receiver for receiving coordinate data from the electronic fence transmission device;
a post position setting unit for storing the received coordinate data as information on a position where a post is installed;
an electronic fence setting unit for calculating coordinate data of a line connecting posts through the information on the position where the post is installed and storing the calculated coordinate data as information on a position where an electronic fence is installed; and
a stimulation generator for receiving the coordinate data according to the current position from the GPS module at regular time intervals, and generating at least one of an electronic stimulation, a vibration, or a sound when a distance between the received coordinate data and stored position information as the electronic fence is within a predetermined range.

5. The electronic fence apparatus as claimed in claim 1, further comprising:
a storage unit for storing the information on the position where the post is installed and position information set as the electronic fence;
a vibration generator for generating a vibration, the vibration generator coming into contact with a body of an animal;
an electronic stimulation generator for generating an electronic stimulation, the electronic stimulation generator coming into contact with the body of the animal; and
a sound generator for outputting a sound.

6. The electronic fence apparatus as claimed in claim 3, wherein the electronic fence reception device further comprises:
a storage unit for storing the information on the position where the post is installed and position information set as the electronic fence;
a vibration generator for generating a vibration, the vibration generator coming into contact with a body of an animal;
an electronic stimulation generator for generating an electronic stimulation, the electronic stimulation generator coming into contact with the body of the animal; and
a sound generator for outputting a sound.

7. The electronic fence apparatus as claimed in claim 1, wherein, when a number of information on the position where the post is installed is one, the electronic fence setting unit calculates coordinate data of a circle having the information on the position where the post is installed as a central point and sets the calculated coordinate data as the information on the position where the electronic fence is installed.

8. The electronic fence apparatus as claimed in claim 1, wherein the stimulation generator generates the electronic stimulation, the vibration, or the sound having a stronger intensity as the received coordinate data is closer to the position information set as the electronic fence.

9. The electronic fence apparatus as claimed in claim 5, further comprising an RFID reader for, when the post is actually installed, reading an RFID tag installed in the post,
wherein, when tag information of the RFID tag read through the RFID reader corresponds to preset tag information, the stimulation generator generates at least one of the electronic stimulation, the vibration, or the sound.

10. The electronic fence apparatus as claimed in claim 6, further comprising an RFID reader for, when the post is actually installed, reading an RFID tag installed in the post,
wherein, when tag information of the RFID tag read through the RFID reader corresponds to preset tag information, the stimulation generator generates at least one of the electronic stimulation, the vibration, or the sound.

11. The electronic fence apparatus as claimed in claim 2, further comprising:
a storage unit for storing the information on the position where the post is installed and position information set as the electronic fence;
a vibration generator for generating a vibration, the vibration generator coming into contact with a body of an animal;
an electronic stimulation generator for generating an electronic stimulation, the electronic stimulation generator coming into contact with the body of the animal; and
a sound generator for outputting a sound.

12. The electronic fence apparatus as claimed in claim 4, wherein the electronic fence reception device further comprises:
a storage unit for storing the information on the position where the post is installed and position information set as the electronic fence;
a vibration generator for generating a vibration, the vibration generator coming into contact with a body of an animal;
an electronic stimulation generator for generating an electronic stimulation, the electronic stimulation generator coming into contact with the body of the animal; and
a sound generator for outputting a sound.

13. The electronic fence apparatus as claimed in claim 2, wherein, when a number of information on the position where the post is installed is one, the electronic fence setting unit calculates coordinate data of a circle having the information on the position where the post is installed as a central point and sets the calculated coordinate data as the information on the position where the electronic fence is installed.

14. The electronic fence apparatus as claimed in claim 3, wherein, when a number of information on the position where the post is installed is one, the electronic fence setting unit calculates coordinate data of a circle having the information on the position where the post is installed as a central point and sets the calculated coordinate data as the information on the position where the electronic fence is installed.

15. The electronic fence apparatus as claimed in claim 4, wherein, when a number of information on the position where the post is installed is one, the electronic fence setting unit calculates coordinate data of a circle having the information on the position where the post is installed as a central point and sets the calculated coordinate data as the information on the position where the electronic fence is installed.

16. The electronic fence apparatus as claimed in claim 2, wherein the stimulation generator generates the electronic stimulation, the vibration, or the sound having a stronger intensity as the received coordinate data is closer to the position information set as the electronic fence.

17. The electronic fence apparatus as claimed in claim 3, wherein the stimulation generator generates the electronic stimulation, the vibration, or the sound having a stronger intensity as the received coordinate data is closer to the position information set as the electronic fence.

18. The electronic fence apparatus as claimed in claim 4, wherein the stimulation generator generates the electronic stimulation, the vibration, or the sound having a stronger intensity as the received coordinate data is closer to the position information set as the electronic fence.

19. The electronic fence apparatus as claimed in claim 11, further comprising an RFID reader for, when the post is actually installed, reading an RFID tag installed in the post,
wherein, when tag information of the RFID tag read through the RFID reader corresponds to preset tag information, the stimulation generator generates at least one of the electronic stimulation, the vibration, or the sound.

20. The electronic fence apparatus as claimed in claim 12, further comprising an RFID reader for, when the post is actually installed, reading an RFID tag installed in the post,
wherein, when tag information of the RFID tag read through the RFID reader corresponds to preset tag information, the stimulation generator generates at least one of the electronic stimulation, the vibration, or the sound.
